(19) United States
(12) Patent Application Publication
(10) Pub. No.: US 2004/0263695 A1
(43) Pub. Date: Dec. 30, 2004

(54) Multi-processor media center

(76) Inventor: Mike J. Castillo, Hillsboro, OR (US)

Correspondence Address: BUCKLEY, MASCHOFF, TALWALKAR LLC, 5 ELM STREET, NEW CANAAN, CT, 06840, US

(21) Appl. No.: 10/609,705

(22) Filed: Jun. 30, 2003

(51) Int. Cl. H04N 7/173; H04N 7/16; H04N 5/50

(52) U.S. Cl. 348/731; 725/131; 725/139; 725/151

(57) ABSTRACT

According to some embodiments, a multi-processor media center is provided.

### BACKGROUND

A media center may receive, process, store, retrieve, create, and/or provide image information. For example, a media center might play movies based on information that is received via a tuner (e.g., from a cable or satellite system) or retrieved from a high speed storage device (e.g., a hard disk drive). The media center may further provide a user interface, such as an interface associated with an electronic program guide.

### BRIEF DESCRIPTION OF THE DRAWINGS

FIG. 1 is block diagram of a multi-processor media center according to some embodiments.

FIG. 2 is block diagram of system that includes a multi-processor media center according to some embodiments.

FIG. 3 is an example of a system that includes a multi-processor media center according to some embodiments.

FIG. 4 is a flow diagram of a method associated with a control processing block according to some embodiments.

FIG. 5 is a flow diagram of a method associated with an image processing block according to some embodiments.

### DETAILED DESCRIPTION

Some embodiments described herein are associated with a “media center.” As used herein, the phrase media center may refer to, for example, a system that uses multiple processors to receive, process, store, retrieve, create, and/or provide audio and image information. For example, the media center might process information (e.g., to play a movie) in accordance with the Motion Picture Experts Group (MPEG) 1 protocol as defined by International Organization for Standardization (ISO)/International Engineering Consortium (IEC) document number 11172-1 entitled “Information Technology—Coding of Moving Pictures and Associated Audio for Digital Storage Media” (1993).

Similarly, the media center might process information (e.g., to play music) in accordance with the MPEG1 audio layer 3 (MP3) standard and format for compression of audio information.

As still another example, the media center might retrieve information stored on a DVD and process the information in accordance with the MPEG2 protocol as defined by ISO/IEC document number 13818-1 entitled “Information Technology—Generic Coding of Moving Pictures and Associated Audio Information” (2000).

Other examples of information that might be processed include information in accordance with the MPEG4 protocol as defined by ISO/IEC document number 14496-1 entitled “Information Technology—Coding of Audio-Visual Objects” (2001), standard definition television signals, and Advanced Television System Committee (ATSC) signals.

Moreover, a media center may be associated with a television, a tuner, a receiver, a set-top box, and/or a Digital Video Recorder (DVR). The media center may comprise one or many devices, each of which may have fewer or more components than described herein. Similarly, the media center may be a component or attachment of another device having functionality that may differ from that provided by the media center (e.g., a media center component within a television).

Media content providers offer a wide variety of video and audio programming that may be delivered to a consumer through various means. For example, content may be provided via coaxial cable, copper phone lines, satellite, microwave, and/or Radio Frequency (RF) transmissions. The transmitted signals may be provided in digital format, and may be compressed to increase the amount of data that can be distributed. Examples of digital video compression algorithms include the MPEG2, MPEG4, QuickTime™, and Intel® Indeo™ standards.

In such cases, digital programming may be decompressed prior to being formatted for display. Decompression may be performed by a consumer device, such as a television or a video tuner/receiver. A video tuner/receiver, sometimes referred to as a “set-top box,” may be incorporated into other devices (like a television set), or may be a stand-alone device. Set-top boxes may also be equipped with added functionality enabling them to distribute and serve media content to other devices (e.g., located in a user's house). This type of set-top box is one example of a media center, also referred to as a home media server.

To provide the distribution, graphics, networking functionality, and/or user controls to a basic set-top box, a traditional Personal Computer (PC) architecture may be used. The use of a PC architecture may further provide media storage capabilities. For example, a DVR device (e.g., a TIVO™, ReplayTV™, and Moxi™ or device) may store and provide image information. In some cases, however, a traditional PC architecture might degrade the quality of image information displayed to a user.

For example, a PC-based media center may have television tuners and/or decoders that exchange information with a PC processor via a Peripheral Component Interconnect (PCI) interface as defined by the PCI Special Interest Group (SIG) in “PCI Local Bus Specification Revision 2.2” (Dec. 18, 1998) (e.g., media signals received by a tuner may be passed to a PC processor via a PCI bus). The PC processor may then process the media signals and supply information to a graphics processor (which will generate an image frame to be displayed). Because the PCI bus is not isochronous, the media signals may not be passed to the graphics card in time for the display of the next frame. This latency may degrade the quality of the image provided to a user by creating interruptions or glitches in the media stream.

Media Center

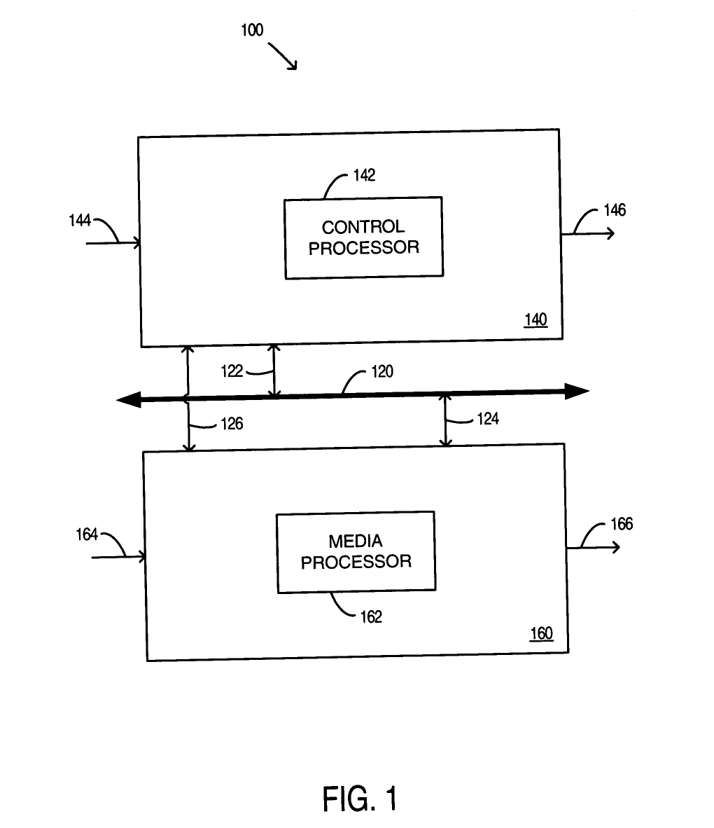

FIG. 1 is a block diagram of a multi-processor media center 100 according to some embodiments. The media center 100 includes a system bus 120, a control processing block 140, and a media processing block 160. The control processing block 140 and the media processing block 160 may function autonomously and coordinate activity over the shared system bus 120. The system bus 120 may be, for example, a PCI bus, and has connections 122, 124 to both processing blocks 140, 160 respectively. The system bus could also be associated with, for example, an Industry Standard Architecture (ISA) interface, an Enhanced Industry Standard Architecture (EISA) interface, a MicroChannel Architecture (MCA) interface, a Video Electronics Standards Association (VESA) interface, and/or a VESA Local Bus (VL-Bus) interface. Although only the processing blocks 140, 160 are shown connected to the system bus 120, other devices and/or components may be similarly connected.

In some embodiments, there is a direct connection 126 between the processing blocks 140, 160. The direct connection 126 between the processing blocks 140, 160 may have bus architectures similar to that of the system bus 120. According to other embodiments, the direct connection 126 has an isochronous bus architecture, such as one in accordance with the International Telecommunications Union Radio-Communications Sector Recommendation for Broadcasting Service (Television) number 656, version 4, February 1998 (ITU-R BT.656-4) and/or the Inter-Integrated Circuit Sound (12S) architecture.

The control processing block 140 contains a control processor 142 and input and output paths 144, 146. The control processing block 140 may, in some embodiments, be a general purpose PC processor. The input path 144 may be a direct or wireless connection to a user device (e.g., a remote control) to provide input to the control processing block 140. The output path 146 may allow signals to be transmitted to other devices or components. Note that a plurality of input paths 144 and/or output paths 146 may be provided. The control processor 142 may be any know or available type of processing unit, such as an Intel® IXP 2800 network processor or an Intel® XEON™ Processor coupled with an Intel® E7501 chipset. In some embodiments, the control processor 142 comprises multiple inter-connected processors.

The media processing block 160 contains a media processor 162 and an isochronous input and/or output path 164, 166. An isochronous input and output path 164, 166 may allow media signals to be transmitted through the media processing block 160 to a display device in a timely fashion (e.g., to maintain the quality of media programming). The media processor 162 may be a video processor, such as one typically used in video tuners/receivers, set-top boxes, and televisions. In other embodiments, the media processor 162 may be any other type of processor capable of managing and processing an isochronous flow of media signals through the media processing block 160.

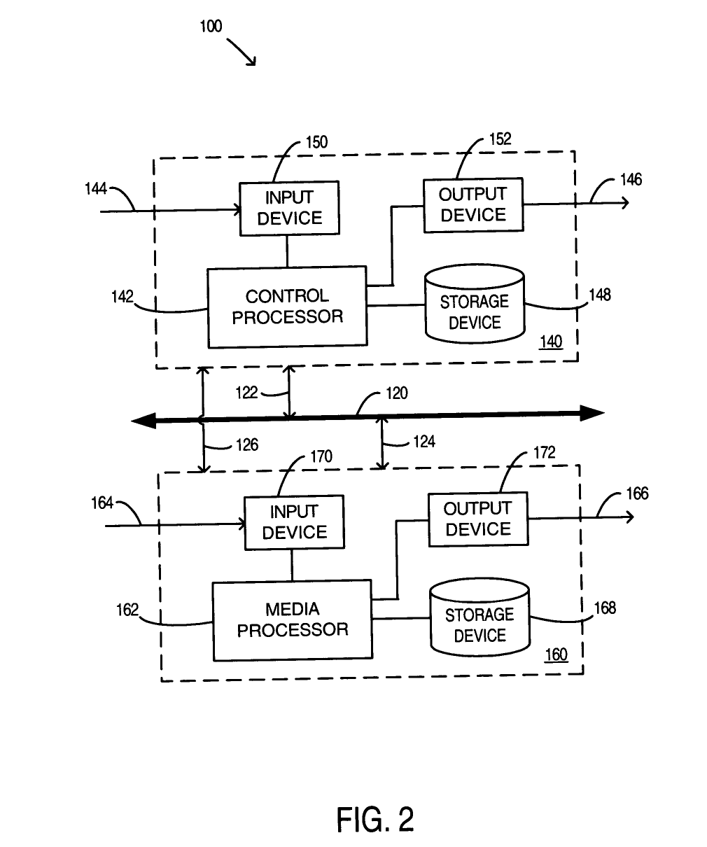

As shown in FIG. 2, the input and output paths 144, 146 may be associated with input and output devices 150, 152 within the control processing block 140. Some examples of an input device 150 include a keyboard, a pointer device (such as a computer mouse), a touch screen, and/or a signal receiver such as an Infrared Radiation (IR) receiver (e.g., for receiving IR command signals from an IR remote control). The input device 150 may comprise one or more components and may reside within, attached to, or external to the control processing block 140 and/or the media center 100. In some embodiments, multiple input devices 150 may connect to multiple input paths 144. According to other embodiments, a single input path 144 may connect to multiple input devices 150, or an input device 150 may not be associated with any input path 144. Note that the input device 150 may be connected to the control processor 142 and that other components within or external to the control processing block 140 may connect (directly or indirectly) to the input device 150.

According to some embodiments, a user may submit a command to the control processing block 140 by sending a signal through the input path 144 to the input device 150. The input device 150 may interpret the user command and/or transmit the command to the control processor 142. The control processor 142 may also interpret or otherwise manipulate the command and may further undertake processing steps and/or direct other components of the control processing block 140 (or the media processing block 160) in accordance with the command.

In some embodiments, the control processing block 140 may receive a media signal from the media processing block 160. The media signal may be transmitted through the system bus 120 or may be transmitted a direct isochronous path 126. For example, the user may instruct the control processing block 140 to record a media signal from the media processing block 160 on a storage device 148, or to distribute the media signal to one or more output devices 152. In such an embodiment, the control processing block 140 may receive a media signal from the media processing block 160 and store or distribute the signal as appropriate. In some embodiments, the media signal may automatically and/or continuously be received at the control processing block 140, or the media signal may be received in response to a user command being processed and relayed to the media processing block 160.

The storage device 148 may an internal or external device and may include a hard disk drive, physical memory, virtual memory, Random-Access Memory (RAM), a DVD, and/or a Compact Disc (CD). The storage device 148 may store any information associated with the control processing block 140 including user information, programs, and media signals.

The output device 152 may be any device internal or external to the control processing block 140 that receives information, signals, and/or commands distributed by the control processor 142. Examples of output devices 152 include a television, a computer or computer monitor, a Personal Digital Assistant (PDA), a modem or telephone, a network (wired or wireless), and/or a Video Cassette Recorder (VCR). The output device 152 may comprise one or more components and may reside within, attached to, or external to the control processing block 140. In some embodiments, multiple output devices 152 may connect to multiple output paths 146. According to some embodiments, a single output path 146 may connect to multiple output devices 152, or an output device 152 may not be associated with any output path 146. Note that the output device 152 may be connected to the control processor 142 and that other components (within or external to the control processing block 140) may also connect to the output device 152.

In some embodiments, the media processing block 160 may include one or more input devices 170, output devices 172, and/or storage devices 168. The storage device 168, input device 170, and output device 172 may be of the same types as described with respect to the control processing block 140 or may be any other types of devices.

According to some embodiments, the input device 170 is a video or television tuner for receiving media signals. Note that the media signals may be audio or video, analog or digital, and may relate to television or satellite programming, video games, movies, and/or Internet content. For example, the media signals may be National Television Standards Committee (NTSC) or Advanced Television System Committee (ATSC) signals and may include multiple signal streams.

The output device 172 may be a display device (such as a television) or a receiving device (such as a digital tuner/receiver). In some embodiments, for example, NTSC and/or ATSC programming signals may be received by an input device 170 through input connection 164 and the media processor 162 may process the signals and write information to a storage device 168 and/or transmit them to an output device 172 for viewing via output path 166. The storage device 168, input device 170, and output device 172 may reside within, attached to, or external to the media processing block 160 and media center 100. In some embodiments, multiple storage devices 168, input devices 170, and/or output devices 172 are provided.

### EXAMPLE

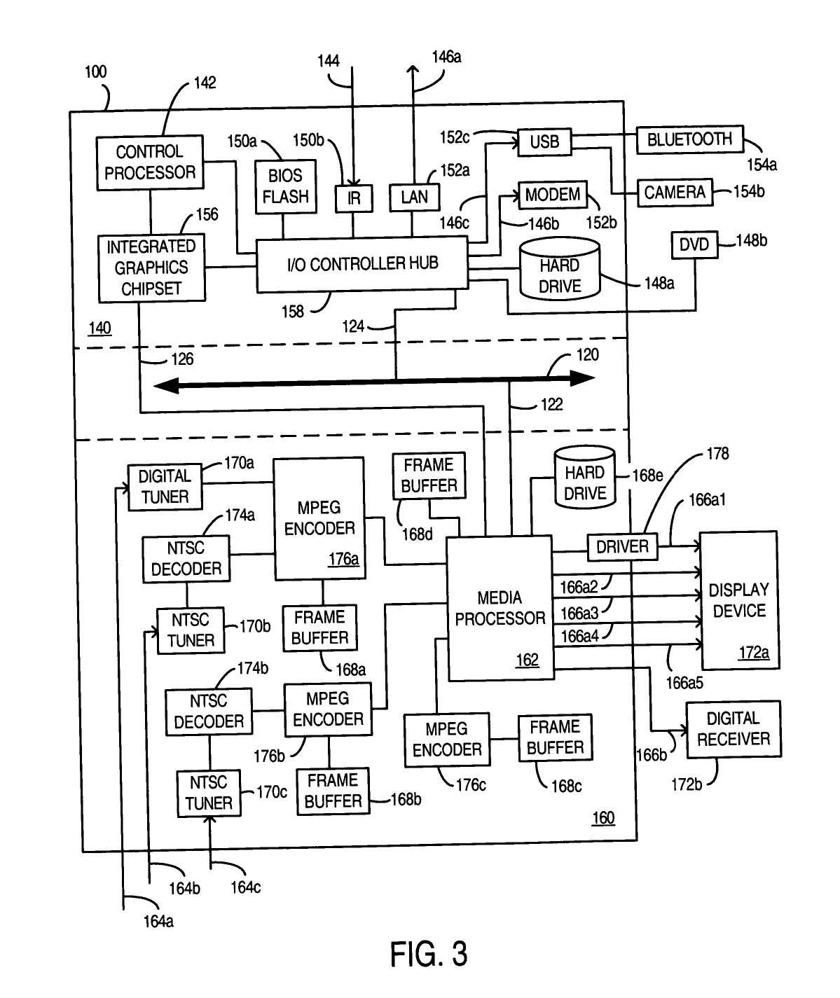

Turning now to FIG. 3, an example of system including a multi-processor media center 100 is provided. According to some embodiments, a user may enter a command into an IR remote control aimed at an IR input device 150b of the control processing block 140. The IR command signal entered by the user travels through input path 144 and into the IR input device 150b. In some embodiments, an Input/Output (I/O) controller hub 158 receives the command signal from the IR input device 150b and distributes the signal to the appropriate component of the control processing block 140. Moreover, a Basic Input/Output System (BIOS) flash memory device 150a may directly supply a command signal to the I/O controller hub 158, without requiring user input through an input path 144. For example, the BIOS may store commands to direct the control processing block 140 to perform certain actions upon the occurrence of a pre-determined condition.

The I/O controller hub 158 may send a command signal to the control processor 142. The control processor 142 may then interpret or process the command signal to determine what action or response is appropriate. In some embodiments, the command indicates that the control processing block 140 should write information to a hard disk drive 148a or a DVD storage device 148b (e.g., to record images being processed the media processing block 160. The BIOS may also provide for such a response in an attempt to preserve data due to a power outage or other condition affecting the media center 100.

If the command indicates that the control processing block 140 should store system, control, and/or command information, the control processor 142 may directly write the information to the appropriate storage device 148a, 148b. If the command indicates that the control processing block 140 should store a media signal, the control processing block 140 may instruct the media processing block 160 to provide the appropriate media signal (e.g., via the I/O controller hub 158 and system bus 120). In some embodiments, the requested data is transmitted from the media processor 162 via an isochronous direct connection 126 to the integrated graphics chipset 156. In other embodiments, the media signal automatically flows to the control processing block 140 (e.g., without requiring a specific request or command to the media processing block 160).

The control processing block 140 may store, create, or modify a menu or graphical item such as an Electronic Program Guide (EPG). The EPG may be loaded into a storage device 148 and/or created within the control processing block 140. Creation or editing of the EPG may be conducted using stored media information and/or media information received or obtained from the media processing block 160. In some embodiments, the control processing block 140 receives media programming information from the media processing block 160 and uses this information to create or edit an EPG. The control processor 142 and an integrated graphics chipset 156 may be used, according to some embodiments, to create and/or edit the EPG. The integrated graphics chipset 156 may be any known or available chipset including, but not limited to, an Intel® 875P chipset or an Intel® 865G chipset with Intel® Extreme Graphics 2. The EPG may then be sent to an output device 152 or may be transmitted to the media processing block 160. In some embodiments, the integrated graphics chipset 156 has a direct isochronous connection 126 to the media processor 162 to facilitate EPG transmission and synchronization with any media signal to be displayed by the media processing block 160. For example, the EPG may be created (e.g., based on information received via the Internet or from the media processing block 160) and transmitted to the media processing block 160 for display on an output device 172, incorporated into (or in place of) a media signal.

In some embodiments, the control processing block 140 may distribute a media signal to one or more output devices 152. For distribution to external devices, a Local Area Network (LAN) output device 152a or a modem output device 152b may connect to an output path 146a, 146b such as a user's home LAN or the Public Switched Telephone Network (PSTN). Any device attached or connected to the output paths 146a, 146b may receive the media signal and/or other information distributed by the control processing block 140. Similarly, a Universal Serial Bus (USB) output device 152c may connect to an output path 146c which further connects to auxiliary output devices 154. For example, a Bluetooth-enabled output devices 154a or a camera output devices 154b may receive media signals. The output devices 152a, 152b, 152c and auxiliary output devices 154a, 154b may reside within, attached to, or external to the control processing block 140. In some embodiments, output devices 152a, 152b, 152c and auxiliary output devices 154a, 154b also transmit commands or information to the control processing block 140 (e.g., acting as input devices 150 or combination input/output devices).

The paths and buses within, to, and/or from the control processing block 140 may use the PCI architecture or other interface. In some embodiments, the direct connection 126 to the media processing block 160 is isochronous.

The media processing block 160 may receive, according to some embodiments, one or more media signals through one or more input paths 164. As shown in FIG. 3, there may be a digital or ATSC input path 164a, a first NTSC input path 164b, and a second NTSC input path 164c. These media signals may be received by input devices 170 such as digital tuners 170a and NTSC tuners 170b, 170c. In some embodiments, the NTSC media signals are decoded, which may be accomplished by NTSC decoders 174a, 174b. The media signals may then be passed to MPEG encoders 176a, 176b that utilize frame buffer storage devices 168a, 168b to pass an uninterrupted media stream to the media processor 162. As shown in FIG. 3, an MPEG encoder 176 may be dedicated to a single media stream (e.g., MPEG encoder 176b) or may be shared by multiple media streams (e.g., MPEG encoder 176a). According to some embodiments, an MPEG encoder 176c and associated frame buffer storage device 168c may be connected to the media processor 162 for use in processing media signals previously stored on a hard disk drive 168e. One or more separate frame buffer storage devices 168d may also be directly connected to the media processor 162 to facilitate media signal processing and/or storage.

The processed media signals or streams are then relayed through output paths 166 to output devices 172 and/or transmitted to the control processing block 140 for further storage, processing, or distribution. In some embodiments, the media signals are transmitted to the control processing block 140 before being processed by the media processing block 160. As shown in FIG. 3, the media signals may be sent to a display output device 172a (such as a television) through output paths 166a and/or a digital receiver output device 172b through another output path 166b. The output paths 166a may be, for example, transmitted via a driver device 178 to a display device 172a. Other media signals and/or components of a single media signal may be transferred to the display device 172a in, for example, YP_{B}P_{R} format 166a2, YC_{B}C_{R} format 166a3, Composite Video Blanking Sync (CVBS) format 166a4, and/or Super-Video (S-Video) format 166a5. The audio component of a media signal may be transmitted through another output path or along with the video components of a media signal. Similarly, output path 166b may be in a Sony/Phillips Digital Interface (S/PDIF) format for transmittal of a digital signal to the digital receiver output device 172b.

The paths and buses within, to, and/or from the media processing block 160 may be isochronous or another time-dependent architecture. In some embodiments, the connection 122 to the system bus 120 is not isochronous.

Methods

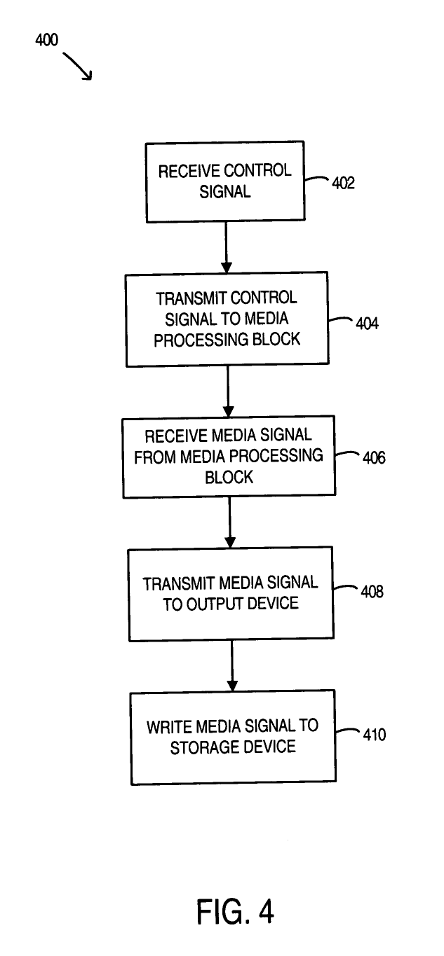

FIG. 4 is a flow diagram of a method 400 according to some embodiments. The flow charts described herein do not necessarily imply a fixed order to the actions, and embodiments may be performed in any order that is practicable. The method of FIG. 4 may be associated with, for example, the control processing block 140 described with respect to FIG. 1. Note that any of the methods described herein may be performed by hardware, software (including microcode), or a combination of hardware and software. For example, a storage medium may store thereon instructions that when executed by a machine result in performance according to any of the embodiments described herein.

At 402, a control signal is received. The control signal may originate from, for example, a user, another device, or an application. The control signal may be a user command (e.g., associated with a graphic interface) or a system-defined command. In some embodiments, the control signal is received through an input path 144 and/or from an input device 150. At 404, the control signal is transmitted to the media processing block 160. The control signal transmitted at 404 may be, for example, the same control signal received at 402, a processed version of the signal from 402, or a control signal created or selected based on the control signal received at 402. The control signal may be transmitted to the media processing block 160 via the system bus 120 and connections 122, 124, or it may be directly transmitted to the media processing block 160 through a direct connection 126.

In some embodiments, a media signal is received at 406 from the media processing block 160. The media signal may include, for example, image information. The media signal may be received in response to a request or other control signal sent to the media processing block 160 or may be received automatically and/or continuously. The media signal, in some embodiments, is then transmitted at 408 to one or more output devices 152. According to some embodiments, the control processing block 140 distributes the media signal to multiple output devices 152. The media signal transmitted at 408 may be a real time stream flowing from the media processing block 160, or may be a previously stored media signal. At 410, the media signal may be written to a storage device 148 (e.g., to a record a television program).

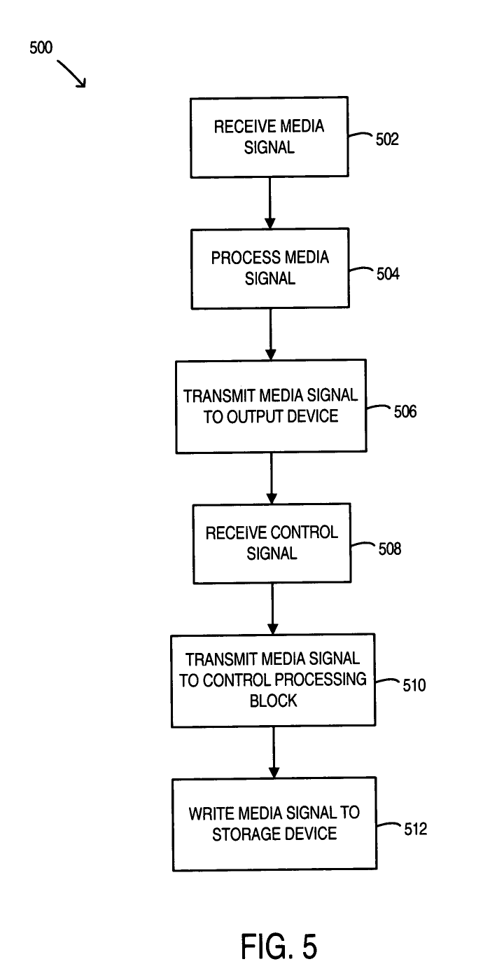

FIG. 5 is a flow diagram of a method 500 associated with a media processing block 160 according to some embodiments. At 502, a media signal is received (e.g., via a tuner). The media signal may, for example, be received through an input path 164 and/or an input device 170. The received media signal is then processed at 504. The processing of the media signal may include encoding, decoding, encrypting, decrypting, compressing, or decompressing, or any other type of signal manipulation that may be appropriate based on the type of media signal received. The processing may be performed by the media processor 162, by an encoding device 176, or by any other component of the media processing block 160.

At 506, the media signal is transmitted to an output device 172. In some embodiments, the receiving at 502, the processing at 504, and the transmitting at 506 are all conducted via isochronous buses such that the media signal flow is not interrupted. At 508, the media processing block 160 receives a control signal from the control processing block 140. In some embodiments, the control signal is received from a device other than the control processing block 140. The control signal may be similar to that described in conjunction with FIG. 4. The media signal is transmitted to the control processing block 140 at 510. The transmitting at 510 may be in response to the receiving of the control signal at 508, or may be performed automatically and/or continuously. In some embodiments, the media signal is stored at 512 in a storage device 168. The media signal transmitted at 510 may be a real time media signal flowing through the isochronous bus of the media processing center 160, or may be a previously stored media signal. The previously stored media signal may originate, for example, from a control processing block 140 storage device 148, a media processing block 160 storage device 168, or an external device or source.

The several embodiments described herein are solely for the purpose of illustration. Persons skilled in the art will recognize from this description other embodiments may be practiced with modifications and alterations limited only by the claims.

What is claimed is:

1. An apparatus, comprising:
a control processor;
a tuner to receive an image signal;
a media processor to receive information from the tuner via a first isochronous path and to provide an output signal to a display device; and
a system bus to exchange information between the control processor and the media processor.

2. The apparatus of claim 1, wherein the system bus is a non-isochronous bus.

3. The apparatus of claim 2, wherein the system bus is a peripheral component interconnect bus.

4. The apparatus of claim 1, wherein the image signal received by the tuner comprises one of: (i) a national television standards committee signal and (ii) a high-definition television signal.

5. The apparatus of claim 1, wherein the first isochronous path includes a moving pictures experts group encoder.

6. The apparatus of claim 1, wherein the media processor is to receive information from a plurality of tuners and a control signal transmitted from the control processor to the media processor via the system bus is associated with one of the tuners.

7. The apparatus of claim 1, wherein the media processor is further to receive an image signal generated by the control processor, and the output signal is based on the information from the tuner and the image signal from the control processor.

8. The apparatus of claim 1, wherein the control processor comprises a general purpose processor.

9. The apparatus of claim 8, wherein the control processor is to execute at least one of the following: (i) a network application, (ii) an Internet application, (iii) a storage application, and (iv) a user interface application.

10. The apparatus of claim 1, further comprising:
a first storage device in communication with the control processor; and
a second storage device in communication with the media processor.

11. The apparatus of claim 1, further comprising:
an integrated graphics chipset having a first connection to the control processor and a second connection to at least one of the media processor and the system bus.

12. The apparatus of claim 1 1, wherein the second connection is a second isochronous path to the media processor.

13. The apparatus of claim 1, further comprising:
an input/output controller hub connected to at least one of the system bus and the control processor.

14. A method, comprising:
receiving at a media processor information from a tuner via a first isochronous path;
receiving at the media processor a control signal from a control processor via a system bus; and
providing an output signal in accordance with the control signal.

15. The method of claim 14, wherein the control signal includes image information and the output signal is based at least in part on the image information.

16. A method, comprising:
receiving a media signal through an isochronous input path;
processing the media signal with a media processor;
providing the processed media signal to an output device through an isochronous output path;
receiving a control signal from a control processor; and
providing at least one of the media signal and the processed media signal via a system bus based on the received control signal.

17. The method of claim 16, further comprising:
storing at least one of the media signal and the processed media signal in a storage device.

18. The method of claim 16, wherein the control signal is associated with an electronic program guide.

19. A method, comprising:
receiving a control signal through an input path of a control processing block;
transmitting a signal to a media processing block;
receiving a signal from the media processing block; and
distributing the signal received from the media processing block to at least one output device.

20. The method of claim 19, further comprising:
storing the signal received from the media processing block in a storage device.

21. The method of claim 19, further comprising:
creating an electronic program guide.

22. The method of claim 21, wherein the signal transmitted to the media processing block is associated with the electronic program guide.

23. The method of claim 19, wherein the signal transmitted to the media processing block is control signal.

24. The method of claim 19, wherein the signal received from the media processing block is at least one of a media signal and a processed media signal.

25. The method of claim 19, wherein the control signal received through the input path is from a user and is associated with a user command.

26. A system, comprising:
a control processor;
a media processor to receive an image signal via a first isochronous path and to provide an output signal to a display device via a second isochronous path;
a non-isochronous system bus to provide a control signal from the control processor to the media processor; and
a storage device to store image information.

27. The system of claim 26, wherein the storage device comprises a hard disk drive in communication with the media processor.

28. A media center, comprising:
a control processor, the control processor being a general purpose processor to: (i) receive a command from a user, (ii) execute a network application, and (iii) generate program guide image information;
a tuner to receive a television signal;
a moving pictures expert group encoder to receive isochronous information from the tuner;
a media processor adapted to process image information, the media processor to (ii) receive isochronous information from the encoder tuner along with program guide image information from the control processor and (ii) provide a processed image signal to a display device; and
a non-isochronous system bus coupled to the control processor and the media processor.

29. The media center of claim 28, wherein the control processor transmits a control signal to the media processor via the system bus in accordance with a command from a user.
